(19) United States
(12) Patent Application Publication
(10) Pub. No.: US 2005/0161886 A1
(43) Pub. Date: Jul. 28, 2005

(54) Heat-activated expandable seal and method for producing same

(76) Inventor: David H. Berry, Northville, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/766,570

(22) Filed: Jan. 28, 2004

(51) Int. Cl. F16L 17/00

(52) U.S. Cl. 277/605

(57) ABSTRACT

A seal (10) includes a hot-melt polymer (12) with a foaming agent, and a heating agent (18) for providing heat to at least partially melt the hot-melt polymer (12) and to activate the foaming agent. A heat conductive barrier (16) is disposed between the hot-melt polymer (12) and the heating agent (18) to inhibit mixing of the heating agent (18) with the hot-melt polymer (12). This reduces the likelihood that the hot-melt polymer (12) will burn if the heating agent (18) produces a large quantity of heat, and also helps to ensure that the hot-melt polymer (12) will be uncontaminated by the heating agent (18) and will therefore form an effective seal. When the foaming agent is activated by the heat, it produces gas to expand the partially melted hot-melt polymer (12) to fill gaps and form an effective seal.

### BACKGROUND OF THE INVENTION

1. Field of the Invention

The present invention relates to a heat-activated expandable seal and a method of producing same.

2. Background Art

Many different types of seals are used to prevent the ingress of water, wind, noise and dust through openings around doors, windows and various other components which are used as barriers against an environment. For example, in automobiles, trunk seals, boot seals, hatch seals and swing-gate seals, just to name a few, are used in addition to door and window seals. Many of these seals are mounted on a flange, or other structural component, and must remain tightly mounted on the flange in order to be effective. A seal that mounts tightly on a flange tends to be more effective than one that fits loosely; however, a tight-fitting seal is more difficult to install. Thus, a tension exists between the need to provide a seal that can be tightly fitted to a structural component, versus the need to have a seal which can be easily installed. Therefore, a need exists for a seal which can be installed with an initial loose fit, and then subsequently secured with a tighter fit, to provide an effective seal.

One attempt to deal with this issue is discussed in U.S. Pat. No. 6,520,505 issued to Kögler et al. on Feb. 18, 2003. Kögler et al. discusses the use of an expandable seal used for sealing a gap between a leadthrough in a constructional element and an object extending through the leadthrough. The seal is formed by placing a number of elongate bar-shaped hot-melt elements in a gap between the leadthrough wall and an object extending through the leadthrough. After the gap has been filled with the hot-melt elements, the elements are heated, for example with a hot air gun. Because the hot-melt elements contain a heat-activated blowing agent, the hot-melt elements begin to melt and then expand when heat is applied. In order to ensure that the seal remains in an expanded condition, Kögler et al. notes that a heat-activated or blocking hardener may be used with the hot-melt elements.

Although Kögler et al. discusses the use of an external heat source to exclusively provide the heat required to activate the blowing agent, it also discusses the use of chemicals to provide an exothermic reaction to internally produce heat. In particular, Kögler et al. discusses the use of a reaction between the heat-activated or blocking hardener and the hot-melt element polymers. Such a reaction may produce enough heat to activate the blowing agent in the hot-melt elements.

One limitation of the seal described in Kögler et al. is that it relies on the use of an external heat source, or alternatively, on the use of chemicals which are compatible with the hot-melt polymers. For example, it may be found that a particular exothermic reaction produces heat in the quantity desired, and at the rate desired, to effect proper activation of a hot-melt element. Yet, it may not be possible to employ that particular exothermic reaction if the chemicals necessary to produce the reaction are incompatible with the hot-melt polymers. For example, the chemicals must either react with the hot-melt polymers to produce the heat—as discussed in Kögler et al.—or alternatively, separate chemicals must be added to the hot-melt elements to produce the desired reaction. First, it may not be possible to produce the desired reaction with chemicals that react with the hot-melt polymers. Second, the use of additional chemicals in the hot-melt elements may degrade the hot-melt polymer, or render it ineffective as a seal.

Therefore, the need exists for an expandable heat-activated seal that is capable of internal heat production that does not require a reaction with the sealing material, and further, does not degrade the sealing material, thereby rendering the seal ineffective.

### SUMMARY OF THE INVENTION

Accordingly, the present invention provides a heat-activated expandable seal that contains a heating agent to facilitate expansion of the seal, where the heating agent is separated from the sealing material to prevent contamination of the sealing material.

The invention also provides a heat-activated seal having a heating agent that is separated from the sealing material to prevent burning of the sealing material when the heating agent is activated.

The invention further provides an expandable seal capable of sealing a gap. The seal includes a polymeric material including a foaming agent. A heating agent is provided to at least partially melt the polymeric material and to activate the foaming agent, thereby facilitating expansion of the polymeric material to effect a seal. A heat conductive barrier surrounds at least a portion of the heating agent, thereby inhibiting mixing of the polymeric material and the heating agent. At least some of the polymeric material is in contact with an external surface of the barrier. This facilitates heat transfer from the heating agent to the polymeric material.

The invention also provides an expandable seal configured for attachment to a flange and capable of sealing a gap proximate the flange. The seal includes an elongate member having a generally U-shaped cross section and configured to be disposed over at least a portion of a flange such that a gap exists between the elongate member and the flange. A polymeric material including a foaming agent is disposed on an inside surface of the elongate member. A heating agent provides heat to at least partially melt the polymeric material and to activate the foaming agent. This facilitates expansion of the polymeric material to fill at least a portion of the gap. A heat conductive barrier surrounds at least a portion of the heating agent, thereby inhibiting mixing of the polymeric material and the heating agent. At least some of the polymeric material is in contact with an external surface of the barrier, thereby facilitating heat transfer from the heating agent to the polymeric material.

The invention further provides a method for producing an expandable seal having an integral heating agent. The method includes disposing a heat conductive barrier around at least a portion of the heating agent. A polymeric material is disposed on an external surface of the barrier, thereby facilitating heat transfer from the heating agent to the polymeric material. The polymeric material includes a heat-activated foaming agent for facilitating expansion of the polymeric material to effect a seal.

### BRIEF DESCRIPTION OF THE DRAWINGS

FIG. 1 shows a cross section of a seal in accordance with the present invention;

FIGS. 2A-2C illustrate a method of producing a seal, such as the seal shown in FIG. 1;

FIG. 3 shows a perspective view of a seal in accordance with the present invention after initial installation on a flange; and

FIG. 4 shows a cross-section of the seal from FIG. 3 after the heating agent has been activated and the hot-melt expanded to fill gaps on either side of the flange.

### DETAILED DESCRIPTION OF THE PREFERRED EMBODIMENT(S)

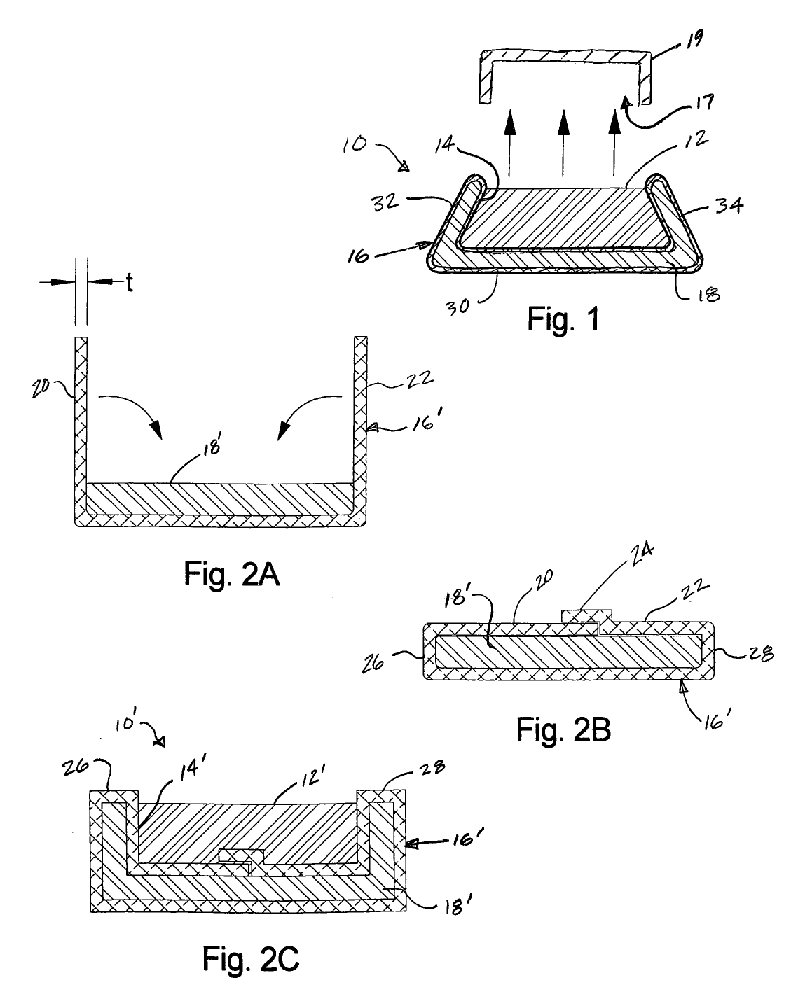

FIG. 1 shows the cross section of a seal 10 in accordance with the present invention. The seal 10 includes a polymeric material, or hot-melt 12 that includes a foaming agent. The hot-melt 12 is in contact with an external surface 14 of a heat conductive barrier 16. As described more fully below, the barrier 16 surrounds a heating agent 18, and inhibits mixing of the heating agent 18 with the hot-melt 12.

In general, the seal 10 is effective to seal a gap through activation of the heating agent 18, which produces heat which is transferred to the hot-melt 12. The hot-melt 12 has a melting point at a first temperature which is exceeded when the heating agent 18 is activated. The foaming agent within the hot-melt 12 may be conveniently chosen such that it is activated at a second temperature that is higher than the melting point of the hot-melt 12. In this way, the hot-melt 12 begins to soften and/or melt prior to activation of the foaming agent. Thus, when the foaming agent is activated, gas is formed and the foaming agent undergoes an increase in volume, and the hot-melt 12 is expanded outwardly as shown in FIG. 1 by the directional arrows. As the hot-melt 12 expands, it fills a gap 17 between the seal 10 and a structure 19, which can be part of a door, window, or any other structure that would benefit from a seal. One type of foaming agent that can be used for this purpose is azodicarbonamide, though other foaming agents may be used.

By including the barrier 16 between the heating agent 18 and the hot-melt 12, the heating agent 18 does not need to be reactive with the hot-melt 12 to produce the desired heat. In addition, the heating agent 18 may be of a material that would otherwise contaminate or render the seal ineffective if it were to mix with the hot-melt 12. A heating agent can be any material or combination of materials that is effective to heat the hot-melt and activate the foaming agent. Examples include various combinations of fuels and oxidizers. For instance, a convenient material to use as a heating agent, such as the heating agent 18, is a thermite compound, which may include ferric oxide as an oxidizer and silicon and/or boron as a fuel. The heating agent 18, before activation, may be in the form of a solid or semi-solid, or even a viscous liquid. It may be convenient, however, to use a thermite compound in the form of a powder that can be easily contained and packed within a barrier, such as the barrier 16.

The heating agent 18 may be activated in any of a number of different ways. For example, a hot probe, or other heat source, can be used to activate a portion of the heating agent 18. Alternatively, microwave or laser energy can be used to activate some heating agents. Once activated, the heating agent 18 will itself produce heat. Thus, by this method, only a small amount of heat needs to be added from an external source; most of the heat is generated internally—i.e., generated by the heating agent 18, which is integral to the seal 10. Alternatively, an igniter (not shown), may be placed within a heating agent, such as the heating agent 18. Such an igniter can be configured with a rip cord, or other mechanical device, that when activated, generates a spark to activate the heating agent. A seal having such a configuration, therefore, does not need any external heat source to activate the heating agent.

In order to effect heat transfer from the heating agent 18 to the hot-melt 12, the barrier 16 is heat conductive. Any type of polymeric or metallic material that is effective to transfer the heat from the heating agent 18 to the hot-melt 12 can be used. Because of their heat conductive properties and manufacturability, the barrier may include one or more of the following materials: aluminum, brass, copper, nickle, iron or steel. In addition, the barrier 16 may be in the form of a sheet of material chosen to have an average thickness that is between 0.005 inches and 0.050 inches. Of course, barriers having thicknesses outside this range may also be used. Because a heating agent, such as the heating agent 18, may produce heat at a very high temperature, the barrier 16 also acts to protect the hot-melt 12 from burning.

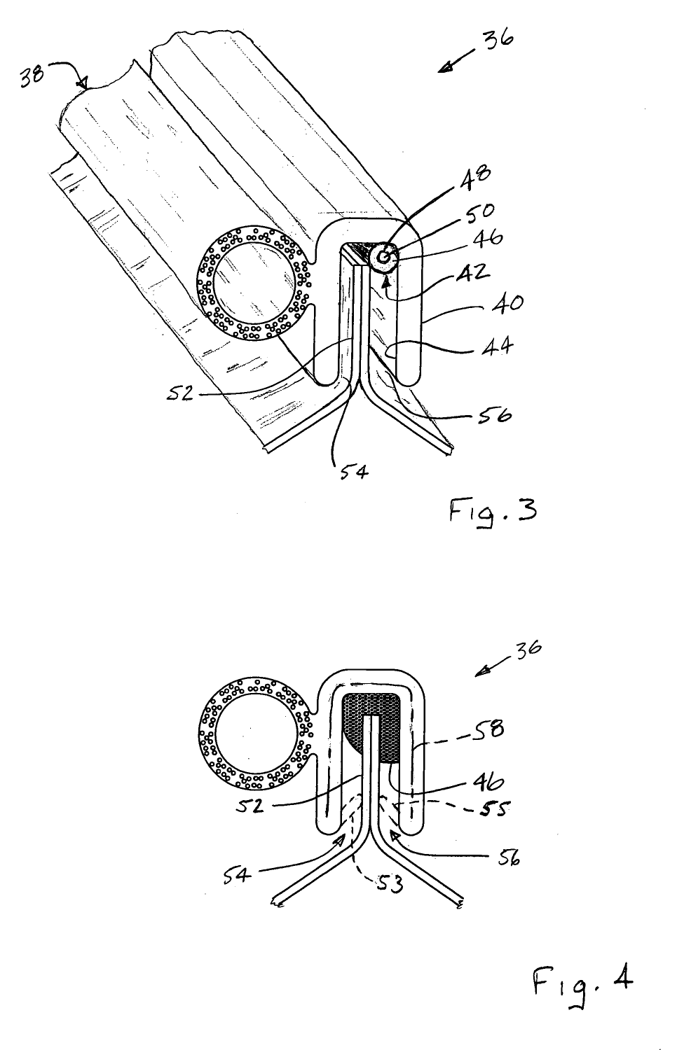

FIGS. 2A-2C show a method of producing a seal, such as the seal 10 shown in FIG. 1. In FIG. 2A, a cross section of a copper barrier 16′ is shown folded into a three-sided trough to allow a thermite compound 18′ to be poured into the trough opening. Although only a cross section of the barrier 16′ is shown in FIG. 2A, it is understood that for purposes of producing a seal, the barrier 16′ may have any convenient length that will allow the finished seal to be used for its intended purpose. This is described more fully below in conjunction with FIG. 3. The barrier 16′, in one embodiment, has a nominal thickness (t) of 0.002 inches. As shown by the directional arrows in FIG. 2A, side portions 20, 22 are folded downward to surround the thermite compound 18′ as shown in FIG. 2B.

As shown in FIG. 2B, the side portion 22 is folded over the side portion 20, thereby forming a seam 24. Of course, the thickness of the barrier 16′ is greatly exaggerated in FIGS. 2A-2C to better convey the process. After the side portions 20, 22 are folded down to surround the thermite compound 18′, end portions 26, 28 may be folded upward to again create a trough-like configuration, as shown in FIG. 2C.

To complete production of the seal, a polymeric material including a heat-activated foaming agent, for example, a hot-melt 12′, is poured into the trough-like configuration such that it is in contact with an exterior surface 14′ of the barrier 16′. Although a barrier, such as the barrier 16′, may be configured to completely surround a heating agent, the barrier may also be configured to leave one or more ends open. For example, the barrier 16′ shown in FIG. 2C is shaped like a trough, having a length that extends into and out of the page. One or both of the ends, which are essentially transverse to the length, may be left open such that small amounts of the thermite compound 18′ may mix with the hot-melt 12′ without appreciably degrading the effectiveness of the seal.

FIG. 2C shows the cross section of a seal 10′ which is configured similarly to the seal 10, shown in FIG. 1. For example, each of the seals 10, 10′ have a barrier 16, 16′ which forms three sides of a quadrilateral. In particular, the seal 10, shown in FIG. 1, has a barrier 16 which forms three sides of a trapezoid—i.e., base 30 and left and right sides 32, 34. The hot-melt 12 is disposed within the trapezoid, which facilitates a generally linear expansion of the hot-melt 12 through the open side of the trapezoid; this is indicated in FIG. 1 by the directional arrows. In this way, the barrier 16 is configured to at least partially direct the expansion of the hot-melt 12 when the foaming agent is activated. Of course, other configurations of a hot-melt, heating agent and barrier can also be used. For example, a sandwich configuration can be utilized, such that a flat barrier surrounds a heating agent and has hot-melt on two opposing external surfaces. Having hot-melt on both sides of the barrier facilitates expansion of the hot-melt in opposite directions, which may be desirable in some applications.

A barrier, such as the barrier 16, may be configured to have various shapes to accommodate particular sealing applications. Another advantage of having a barrier configured as the barrier 16 in FIG. 1, is that it facilitates good heat transfer between the heating agent 18 and a large portion of the hot-melt 12. For example, if the barrier 16 were configured with only the base 30, and without the side portions 32, 34, the heat transfer from the heating agent 18 would be unidirectional—i.e., from the bottom up. Conversely, with the configuration shown in FIG. 1, heat transfer occurs from the bottom and from two sides, thereby more effectively heating the hot-melt 12 prior to activation of the foaming agent. This helps to ensure that the hot-melt 12 has softened or melted enough to be effectively expanded when the foaming agent is activated.

Of course, the quadrilateral shape of the seals 10, 10′ is just one of many different configurations that can be produced in accordance with the present invention. For example, FIG. 3 shows a seal 36 that includes an elongate member 38 which has a cross section that includes a generally U-shaped portion 40. The elongate member may be made from any material effective for the intended purpose, including dense rubber or plastic, sponge rubber, or some combination thereof. The seal 36 also includes an expandable portion 42, which is disposed on an inside surface 44 of the U-shaped portion 40. The expandable portion 42 includes a polymeric material, or hot-melt 46, which contacts both the surface 44 and a barrier 48. As shown in FIG. 3, the barrier 48 is generally cylindrical and surrounds a heating agent 50.

The seal 36 is specifically configured to attach to a structural element, such as a flange 52. The U-shaped portion 40 may optionally include grip fins 53, 55, shown in phantom in FIG. 4, to help retain the seal 36 prior to expansion of the hot-melt 36. The flange 52 may be metal or plastic, and, as shown in FIG. 3, is the kind typically found around an automobile door. The seal 36 is configured such that the U-shaped portion 40 can be disposed over the flange 52 such that a gap initially exists between the U-shaped portion 40 and the flange 52. In particular, as shown in FIG. 3, first and second gaps 54, 56 exist on opposing sides of the flange 52. Because the barrier 48 is cylindrically shaped, and the hot-melt 46 is disposed around it, the hot-melt 46 expands in a generally radial fashion when the foaming agent is activated.

The result of this generally radial expansion is shown in FIG. 4, where the expanded hot-melt 46 has filled a portion of the first and second gaps 54, 56. In addition, interstices and cavities which may extend from the gaps 54, 56, and may be too small to see, will also be filled to promote a good seal. The entry into such interstices and cavities results from the flow of the hot-melt 46, which is essentially of a fluid composition formed as a result of thermal and chemical activity.

Of course, different shapes other than cylindrical—e.g., the quadrilateral shapes shown in FIGS. 1 and 2C—can also be used with a seal, such as the seal 36. The polymeric material, or hot-melt 46, can be made from any of a number of different polymeric materials, including different types of acrylics, acrylonitrile butadiene styrene (ABS), polyethylene, polyurethane-thermoplastic, polypropylene, thermoplastic vulcanizate, thermoplastic elastomer, polyvinylchloride (PVC), silicone and styrenes. The particular choice of polymer may depend on a number of factors, including whether or not it is desired to have the expanded hot-melt adhere to another material. For example, if it is desired to have the expanded hot-melt 46 adhere to the flange 52, the hot-melt polymer may include ethylvinylacetate (EVA). The hot-melt polymer can be chosen such that it adheres well to various materials, including wood, metal, and other polymers, such as plastic.

Having a hot-melt made from an EVA material provides a seal that adheres well to painted metal, such as commonly found in automotive applications. In fact, automotive seals that are configured similarly to the seal 36, but without the expandable portion 42, require a metal or plastic carrier to be used in the U-shaped portion 40, to add rigidity and to maintain stiffness. Such a carrier 58 is shown in phantom in FIG. 4. Using a seal, such as the seal 36 shown in FIGS. 3 and 4, along with an EVA-based hot-melt, such as the hot-melt 46, can eliminate the need for a carrier, thereby reducing weight and/or material costs. Although the specific embodiments discussed in this section involve automotive applications, seals in accordance with the present invention may be used to seal windows and doors in buildings, as well as in other applications that benefit from the use of an expandable hot-melt seal.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An expandable seal capable of sealing a gap, the seal comprising:
a polymeric material including a foaming agent that has the characteristic of undergoing an increase in volume when subjected to an activating influence;
a heating agent for providing heat to at least partially melt the polymeric material and to at least partially activate the foaming agent, thereby facilitating expansion of the polymeric material to effect a seal; and
a heat conductive barrier surrounding at least a portion of the heating agent, thereby inhibiting mixing of the polymeric material and the heating agent, and inhibiting seal degradation,
wherein at least some of the polymeric material is in contact with an external surface of the barrier, thereby facilitating heat transfer from the heating agent to the polymeric material so that interstices and cavities extending from the gap are at least partially filled to promote sealing by a fluid composition formed as a result of thermal and chemical activity.

2. The seal of claim 1, wherein the polymeric material has a melting point at a first temperature, and the foaming agent is activated at a second temperature that is higher than the first temperature.

3. The seal of claim 1, wherein the barrier comprises a sheet of material surrounding a portion of the heating agent, such that the heating agent has at least one open end.

4. The seal of claim 1, wherein the barrier is selected from a group consisting of aluminum, brass, copper, nickel, iron, steel, and mixtures thereof.

5. The seal of claim 1, wherein the barrier has an average thickness from 0.0005 inches to 0.050 inches.

6. The seal of claim 1, wherein the polymeric material is selected from a group consisting of at least one of acrylic, acrylonitrile butadiene styrene, ethylvinylacetate, polyethylene, polyurethane-thermoplastic, polypropylene, thermoplastic vulcanizate, thermoplastic elastomer, polyvinylchloride, silicone, styrene, and mixtures thereof.

7. The seal of claim 1, wherein the foaming agent comprises azodicarbonamide.

8. The seal of claim 1, wherein the heating agent includes a fuel and an oxidizer.

9. The seal of claim 1, wherein the barrier is configured to at least partially direct the expansion of the polymeric material when the foaming agent is activated.

10. The seal of claim 9, wherein the barrier is generally cylindrical, thereby facilitating radial expansion of the polymeric material.

11. The seal of claim 9, wherein a cross section of the barrier forms three sides of a quadrilateral, and the polymeric material is disposed within the quadrilateral, thereby facilitating a generally linear expansion of the polymeric material through an open side of the quadrilateral.

12. An expandable seal configured for attachment to a flange and capable of sealing a gap associated with the flange, the seal comprising:
an elongate member having a cross section that includes a generally U-shaped portion that is configured to be disposed over at least a portion of a flange such that the gap exists between the elongate member and the flange;
a polymeric material including a foaming agent that has the characteristic of undergoing an increase in volume when subjected to an activating influence, the polymeric material being disposed on at least a portion of an inside surface of the elongate member;
a heating agent for providing heat to at least partially melt the polymeric material and to at least partially activate the foaming agent, thereby facilitating expansion of the polymeric material to fill at least a portion of the gap; and
a heat conductive barrier surrounding at least a portion of the heating agent, thereby inhibiting mixing of the polymeric material and the heating agent, and inhibiting seal degradation,
wherein, at least some of the polymeric material is in contact with an external surface of the barrier, thereby facilitating heat transfer from the heating agent to the polymeric material.

13. The seal of claim 12, wherein the polymeric material is configured to adhere to the flange when it expands, thereby eliminating the need for a carrier within the elongate member.

14. The seal of claim 12, wherein the polymeric material has a melting point at a first temperature, and the foaming agent is activated at a second temperature that is higher than the first temperature.

15. The seal of claim 12, wherein the barrier comprises a copper material having a thickness of approximately 0.002 inches.

16. The seal of claim 12, wherein the barrier is configured to at least partially direct the expansion of the polymeric material when the foaming agent is activated.

17. The seal of claim 16, wherein the barrier is generally cylindrical, thereby facilitating radial expansion of the polymeric material such that the polymeric material at least partially fills first and second gaps on opposing sides of the flange.

18. A method for producing an expandable seal having an integral heating agent, the method comprising:
disposing a heat conductive barrier around at least a portion of the heating agent;
disposing a polymeric material on an external surface of the barrier, thereby facilitating heat transfer from the heating agent to the polymeric material, the polymeric material including a heat-activated foaming agent for facilitating expansion of the polymeric material to effect a seal.

19. The method of claim 18, further comprising disposing the polymeric material within an elongate member configured for attachment to a flange, the polymeric material being positioned to at least partially fill first and second gaps on opposing sides of the flange.

20. The method of claim 18, wherein the heating agent includes a fuel and an oxidizer.
